(19) United States
(12) Patent Application Publication
(10) Pub. No.: US 2006/0098822 A1
(43) Pub. Date: May 11, 2006

(54) Interoperable conditional access receptors without consensual key sharing

(76) Inventor: John Kevin Markey, San Diego, CA (US)

Correspondence Address: John Kevin Markey, 12436 Kestrel Street, San Diego, CA, 92129, US

(21) Appl. No.: 11/267,841

(22) Filed: Nov. 4, 2005

Related U.S. Application Data
(60) Provisional application No. 60/631,122, filed on Nov. 5, 2004.

(51) Int. Cl. H04N 7/167

(52) U.S. Cl. 380/210

(57) ABSTRACT

A method and device for forcing the coexistence of different conditional access systems in an existing conditional access system. In one embodiment, the keys used to encrypt the pay television programming are extracted from an incumbent conditional access system and sent in messages to the set top boxes of the competitor manufacturer. In a second embodiment, the key generator in the incumbent system that produces the keys used to encrypt the pay television programming is controlled to produce known keys so that these known keys, or information necessary to predict these known keys, can be distributed to the set top boxes of the competitor manufacturer. In a third embodiment, the keys used to encrypt the pay television programming by the incumbent system are injected into the incumbent system and also distributed to the set top boxes of the competitor manufacturer.

Priority is claimed based on provisional application No. 60/631,122.

### FIELD OF THE INVENTION

The invention relates to the generation and distribution of keys for secure communications.

### DISCUSSION OF THE BACKGROUND

The pay television industry in the United States has grown significantly over the last 25 years. One component of the pay television industry is the manufacturing of equipment for distributing and receiving pay television programming. This equipment includes both “head end” equipment, which is the equipment that is used by a pay television operator to transmit the pay television programming, and subscriber equipment, which is equipment referred to by various names including set top box, descrambler, and IRD (integrated receiver/decoder) that is used to process the pay television signals received from the pay television operator for display on the subscriber's television set.

Pay television equipment usually includes an authorization system, often referred to as a conditional access system, the employs encryption (also sometimes referred to as scrambling) and other methods to prevent the theft of pay television services. The conditional access systems employed by pay television equipment are generally proprietary to the equipment manufacturers and maintained in secrecy to prevent hackers and pirates from defeating them. One consequence of the proprietary and secret nature of these systems is that equipment from different manufacturers is generally not interoperable.

This non-interoperability means that once a system operator selects an equipment manufacturer, the system operator must continue to purchase new equipment—both new subscriber set top boxes and new head end equipment—from the same equipment manufacturer unless the system operator is willing to replace all previously obtained equipment, which is often cost-prohibitive. Thus, an incumbent equipment manufacturer enjoys a great advantage over competing equipment manufacturers once the initial selection of an encryption/conditional access system has been made. Such equipment manufacturers often exploit this advantage in terms of high prices for follow-on equipment purchases and poor service to the consternation of system operators.

There are some systems that provide for the co-existence of equipment from different manufacturers in the same system. For example, head end equipment that complies with the DVB (Digital Video Broadcasting) Simulcrypt standard allows for conditional access systems from different manufacturers to coexist in a single system. However, this standard addresses a situation in which an equipment manufacturer voluntarily allows for the existence of competing conditional access equipment. What is needed is a system and method for forcing the coexistence of encryption/conditional access equipment from a non-incumbent equipment provider in a proprietary system supplied by an incumbent system provider.

### SUMMARY OF THE INVENTION

The present invention provides a method and apparatus for forcing the coexistence of different conditional access systems in an existing conditional access system. In one preferred embodiment, the keys used to encrypt the pay television programming are extracted from an incumbent conditional access system and sent in messages to the set top boxes of the competitor manufacturer. In a second preferred embodiment, the key generator in the incumbent system that produces the keys used to encrypt the pay television programming is controlled to produce known keys so that these known keys, or information necessary to predict these known keys, can be distributed to the set top boxes of the competitor manufacturer. In a third preferred embodiment of the invention, the keys used to encrypt the pay television programming by the incumbent system are injected into the incumbent system and also distributed to the set top boxes of the competitor manufacturer.

### BRIEF DESCRIPTION OF THE DRAWINGS

A more complete appreciation of the invention and many of the attendant features and advantages thereof will be readily obtained as the same become better understood by reference to the following detailed description when considered in connection with the accompanying drawings, wherein:

FIG. 1 is a logical block diagram of a first conventional communication system.

FIG. 2 is a logical block diagram of a second conventional communication system.

FIG. 3 is a logical block diagram of a communication system in which incumbent and competitor set top boxes coexist using control word extraction according to a first preferred embodiment of the present invention.

FIG. 4 is a logical block diagram of a communication system in which incumbent and competitor set top boxes coexist using control word extraction according to a second preferred embodiment of the present invention.

FIG. 5 is a logical block diagram of a communication system in which incumbent and competitor set top boxes coexist using control word prediction according to a third preferred embodiment of the present invention.

FIG. 6 is a logical block diagram of a communication system in which incumbent and competitor set top boxes coexist using control word prediction according to a fourth preferred embodiment of the present invention.

FIG. 7 is a logical block diagram of a communication system in which incumbent and competitor set top boxes coexist using control word prediction according to a fifth preferred embodiment of the present invention.

FIG. 8 is a logical block diagram of a communication system in which incumbent and competitor set top boxes coexist using control word injection according to a sixth preferred embodiment of the present invention.

FIG. 9 is a logical block diagram of a communication system in which incumbent and competitor set top boxes coexist using control word injection according to a seventh preferred embodiment of the present invention.

### DETAILED DESCRIPTION OF PREFERRED EMBODIMENTS

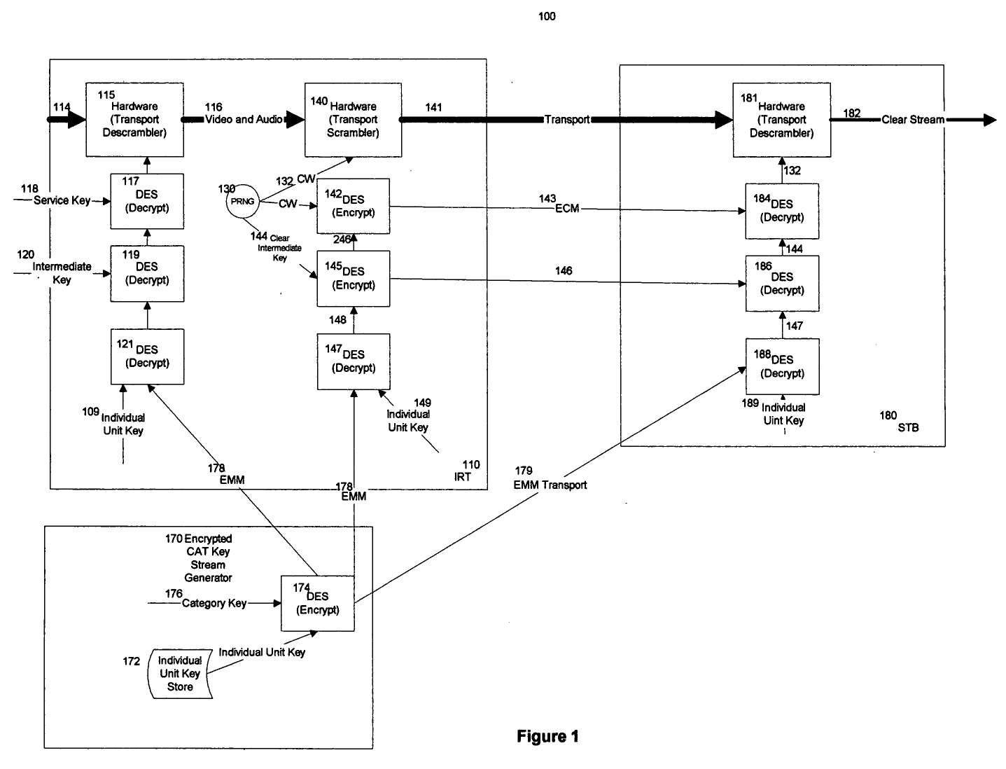

The present invention will be discussed with reference to preferred embodiments of conditional access systems. Specific details, such as number of keys and types of messages, and references to standards such as DVB and DES, are set forth in order to provide a thorough understanding of the present invention. The preferred embodiments discussed herein should not be understood to limit the invention. Furthermore, for ease of understanding, certain method steps are delineated as separate steps; however, these steps should not be construed as necessarily distinct nor order dependent in their performance. The present invention is believed to be particularly applicable to the field of pay television and hence will be discussed primarily in that context. Those of skill in the art will recognize that the invention may be applied in many other settings and is not limited to pay television. Referring now to the drawings, wherein like reference numerals designate identical or corresponding parts throughout the several views, FIG. 1 is a logical block diagram of a conventional conditional access system 100. The system 100 comprises an IRT (integrated receiver transmitter) 110, which is sometimes referred to as a head end. The IRT 110 of FIG. 1 can be conceptually separated into two halves, with the left half representing processing performed on data from a content provider and the right half representing processing performed for distributing the content to subscribers.

The IRT 110 receives a source program stream 114 from a content provider such as HBO, Nickelodeon, etc., which is typically received in encrypted form. Although only a single source program stream is illustrated in FIG. 1, it should be understood that many source program streams may be received at the IRT 110. The encrypted source program stream 114 is decrypted by the source transport descrambler 115 to produce a clear program stream. The source transport descrambler 115 receives a source service key from the DES (data encryption standard) source service key decryptor 1117. The source service key decryptor 117 decrypts the source service key 118, which is typically provided in encrypted form as part of the source program stream 114, but which also may be received separately. This source service key decryptor 117 operates under the control of a key received from a source intermediate key decryptor 119, which decrypts the source intermediate key 120. The source intermediate key decryptor 119 decrypts a key received from the source EMM decryptor 121, which decrypts a key sent in an EMM from the Encrypted CAT Key Stream Generator 170 under the control of an individual unit key 109 stored in a memory (not shown in FIG. 1) of the IRT 110.

In FIG. 1, the Encrypted CAT Key Stream Generator 170 provides category keys to both the left side of the IRT 110, which is responsible for decrypting the source program stream 114, and the right side of the IRT 110, which is responsible for encrypting the source program stream for distribution to end users. Such an arrangement may be found in a system such as HITS (Head End In the Sky) which is responsible for distribution both to and from the IRT 110. In other systems, the source of the category keys for the distribution of information to and from the IRT 110 may be different.

After the source program stream 114 has been decrypted, it can then be reencrypted for distribution to set top boxes 180 (while a single set top box 180 is illustrated in FIG. 1, it should be understood that a plurality of set top boxes 180 may be present). A key generator in the form of a pseudo-random number generator (PRNG) 130 is used to produce keys for encrypting the program streams for distribution to subscribers. As used herein, “pseudo-random number” includes what is sometimes referred to as a “pseudo-random bit stream” and refers to a number (which may or may not be in binary form) that appears to be random but that can be reliably reproduced given a key and, in some instances, an initialization vector. Pseudo random number generators are well known to those of skill in the art and will not be discussed in further detail herein in order to avoid obscuring the invention. It should be understood that pseudo-random numbers produced by pseudo-random number generators vary greatly in terms of quality (e.g., the length of the number before it repeats, the predictability, etc.) and that no particular quality standard is intended by the use of the term pseudo-random. Rather, for the purposes of the invention, it is only necessary that the number appear to be random (of course, the better the pseudo-random number generator is, the more secure the system will be). It should also be understood that a random number generator may be used in place of a pseudo-random number generator.

Keys used for encrypting television programming may be referred to as “control words” in standards such as the DVB standard and will be referred to as control words herein. However, use of the term “control word” should be understood to refer to any keys used for encrypting television programming and should not be understood as being limited to any particular standard or encryption algorithm. The control words 132 produced by the PRNG 130 are used to control a transport scrambler 140, which inputs a decrypted, or clear, program source stream 116 and encrypts it to from an encrypted distribution stream 141. The control words 132 are also encrypted by the control word encryptor 142 for distribution in messages 143 to incumbent set top boxes 180. Messages 143 containing encrypted control words are referred to as ECMs by the DVB standard.

The control word encryptor 142 operates under the control of an intermediate key 144, which may also be produced by the PRNG 130 as shown in FIG. 1. It will be recognized by those of skill in the art that the intermediate key 144 may be generated by a key generator different from the key generator 130. In addition to being sent to the control word encryptor 142, the intermediate key 144 is encrypted by the intermediate key encryptor 145 for transmission to the set top box 180 in an intermediate key distribution message 146.

The intermediate key encryptor 145 operates under the control of a category key 148. The category control key 148 is received in encrypted form in a message 178 (sometimes referred to as an EMM) from the Encrypted CAT Key Stream Generator 170. The encrypted category key message 178 is decrypted by the category key decryptor 147 under the control of an individual unit key 149 that is stored in the IRT 110.

The set top box 180 receives an encrypted distribution stream 141 and decrypts, or descrambles, it using distribution stream descrambler 181. The output of distribution stream descrambler 181, which is a decrypted program stream, is processed using conventional means and output to a receiving device such as a television set (not shown in FIG. 1).

The distribution stream descrambler 181 operates under the control of the control word 132, which is received in encrypted form from the IRT 110 in an ECM message 143 and decrypted by the control word decryptor 184. The control word decryptor 184 operates under the control of the intermediate key 144, which is received in encrypted form from the IRT 110 in a message 146 and decrypted by the intermediate key decryptor 186. The intermediate key decryptor 186 operates under the control of a category key received in encrypted form in an EMM message 179 from the Encrypted CAT Key Stream Generator 170. The encrypted category key is decrypted by the category key decryptor 188, which is controlled, by an individual unit key 189 stored in the set top box 180. It will be understood by those of skill in the art that the individual unit key may be, but is not necessarily, different for each set top box 180 in the system 100.

In the discussion above, the category key is sent to the IRT in a message 178 and sent to the set top box in a message 179. Those of skill in the art will recognize that these messages 178, 179 may contain identical keys in the case of symmetrical encryption algorithms or different but corresponding keys in the case of asymmetrical encryption algorithms.

The Encrypted CAT Key Stream Generator 170 comprises a category key encryptor 174 and encrypts it using individual unit keys corresponding to the various IRTs 110 and set top boxes 180 in the system 100 that are stored in the database 172.

It will be understood by those of skill in the art that FIG. 1 is a logical block diagram of the system 100 and that certain functions illustrated as separate blocks may in fact be performed by the same “device” (as used herein device refers to software, hardware, or a combination of the two that performs some function). As one non-limiting example, it will be readily apparent that the EMM decryptor 121 and the category key decryptor 147 may be the same device.

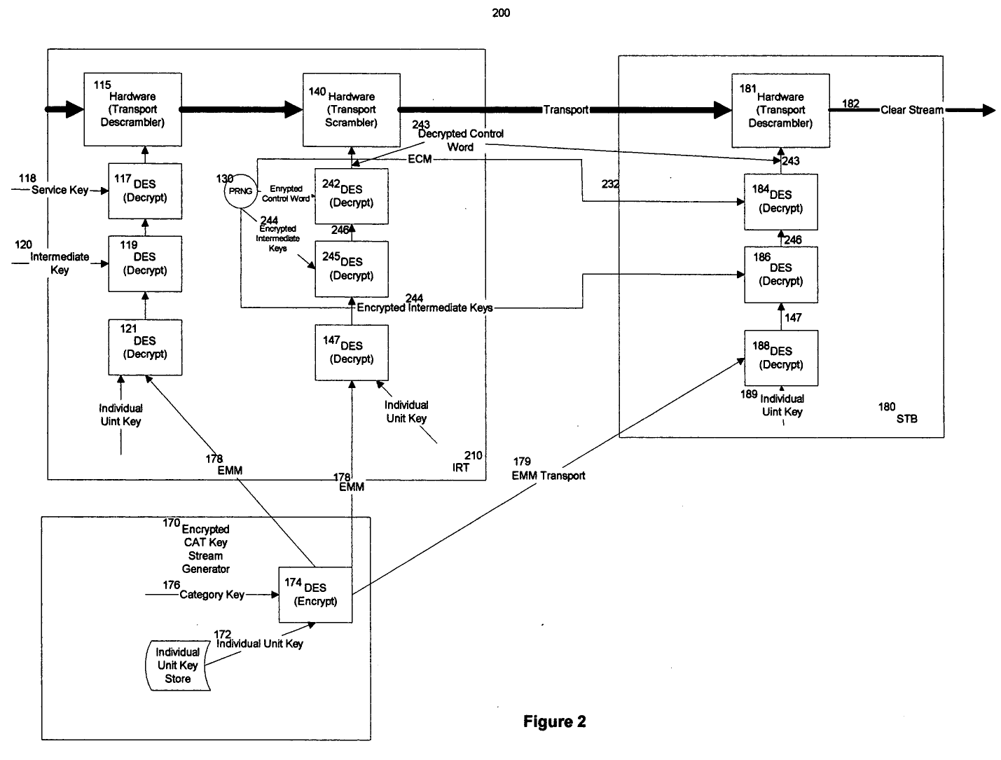

A second known system 200 is shown in FIG. 2. The only differences between FIGS. 1 and 2 are in the IRT 210; the configuration and operation of the set top box 180 and the Encrypted CAT Key Stream Generator 170 are unchanged. Within the IRT 210, it can be seen that the output of the PRNG 130 is treated as an encrypted control word 232 rather than a clear control word 132. This encrypted control word is supplied to a control word decryptor 242, which decrypts the control word 232 for use by the distribution stream scrambler 140. The same encrypted control word 232 is transmitted to the set top box 180, where it is decrypted by control word decryptor 184. Those of skill in the art will recognize that the same device could be used for both the control word decryptor 242 in the IRT 210 and the control word decryptor 184 in the set top box 180.

The intermediate keys 244 are treated in the same manner as the control words 232. That is, the output of the PRNG 130 is treated as an encrypted intermediate key 244 and is decrypted by an intermediate key decryptor 245 to form clear intermediate key 246 in the IRT 210 before being used to control the control word decryptor 242. The encrypted intermediate key 244 is also sent to the set top box 180, where it is decrypted by the intermediate key decryptor 186 to reproduce the same clear intermediate key 246 as used in the IRT 210. Again, this allows identical devices to be used as the intermediate key decryptors 245 and 186 in the IRT 210 and the set top box 180.

The first technique for operating an incumbent system and a competing system together is referred to as key extraction. In this technique, the control words from the incumbent system are extracted and distributed to the set top boxes of the competing system in separate messages. These messages may be distributed as part of the transport stream in which the programming and control messages for the incumbent system are transmitted, or the separate messages may be distributed in an entirely different distribution path. Because the control words themselves are extracted in their unencrypted form, knowledge of the incumbent system's distribution keys (keys other than control words) and techniques is not required.

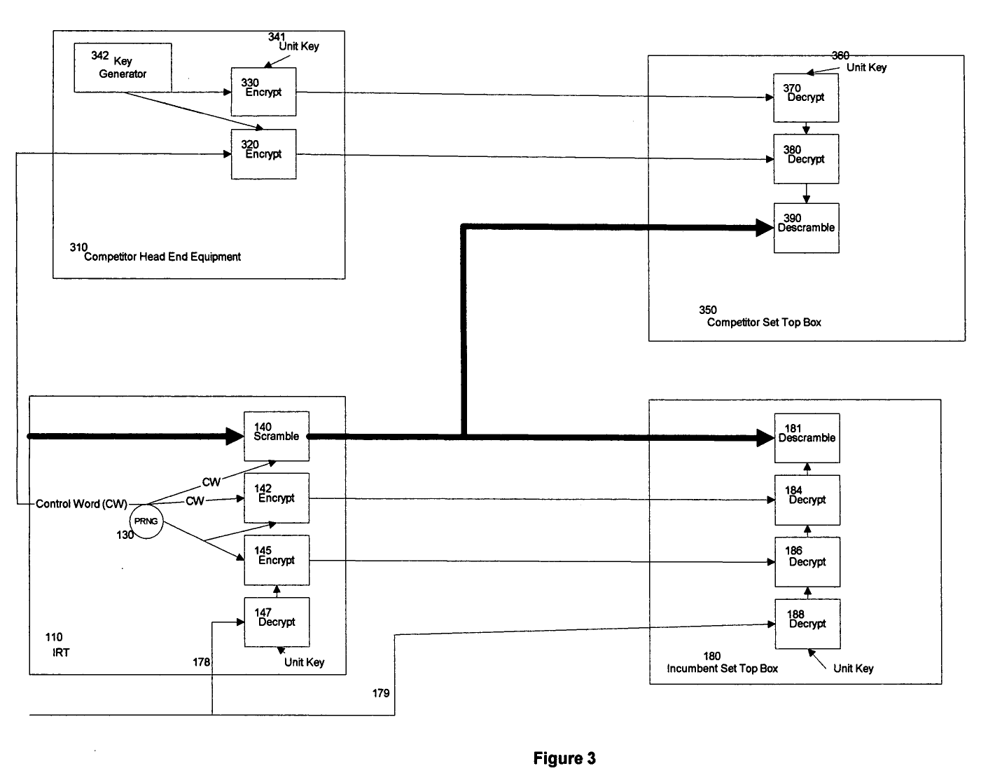

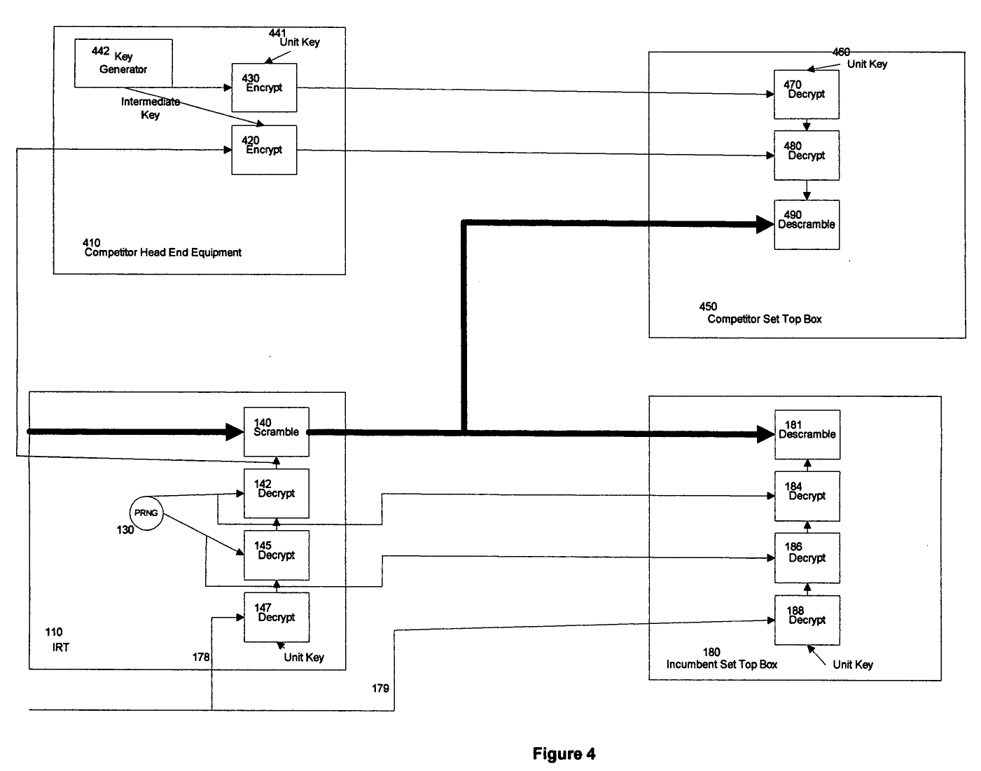

The extraction technique is illustrated in FIGS. 3 and 4, which correspond to the two known systems 100, 200 illustrated in FIGS. 1 and 2, respectively. In FIG. 3, which depicts a system in which the output of the PRNG 130 is treated as unencrypted control words, the control words are extracted at the output of the PRNG 130. These control words are fed into competitor head end conditional access system 310. The competitor head end conditional access system 310 includes an encryptor 320 which encrypts the control words using an intermediate key from a key generator 342. The intermediate key itself is encrypted by encryptor 330 using a unit key (which may be, but is not necessarily, unique to each competitor set top box 350), which is stored in a database 341. The control words and the intermediate key are sent in encrypted form to the competitor set top box 350. The competitor set top box 350 includes a decryptor 370 that decrypts the intermediate key using a unit key stored in its memory 360. The decrypted intermediate key is then used by decryptor 380 to decrypt the encrypted control words. The decrypted control words are used by descrambler 390 to decrypt the encrypted program content. The descrambler 370 is functionally equivalent, if not identical, to the descrambler 181 in the incumbent set top box 180. In the embodiment of FIG. 3, the encrypted control words and the encrypted intermediate key (which are referred to generically as control messages) from the competitor head end equipment 310 are included in the transport stream. The encrypted control word (ECMs) and intermediate key messages (EMMs) from the incumbent system are also present in this transport stream. The control messages from the two systems may be in different elementary streams (e.g., the control messages relating to the competitor system may be injected into the transport stream in the same manner as an additional program stream by the incumbent system), or may be different message types in the same control message elementary stream. In practice, the incumbent set top boxes ignore the control messages from the competitor head end equipment 310, while the competitor set top boxes 350 ignore the control messages from the incumbent IRT 110.

FIG. 4 is similar to FIG. 3 with the exception that the control words from the incumbent IRT 210 are extracted at the output of decryptor 242 rather than from PRNG 130. This is because the output of PRNG 130 is treated as an encrypted control word rather than an unencrypted control word in the system 400 of FIG. 4.

The competitor head end equipment 310, 410 in the systems of FIGS. 3 and 4 utilizes a two level (intermediate key and unit key) encryption mechanism to distribute the control words. It should be understood that any number of levels can be employed to distribute the control words to the competitor set top boxes 350, 450. It should also be understood that any method of encryption/decryption may be utilized by the competitor system to distribute the control words to competitor set top boxes 350, 450.

The second technique for operating an incumbent system and a competing system together is referred to as key prediction. In this technique, the PRNG 130 that generates the control words is analyzed and its functions replicated such that the control words can be reliably reproduced. This may involve controlling or copying the inputs to the PRNG 130 in the incumbent system such that the same values can be input to the replicated pseudo-random number generator, which may be located at the head end or in the set top boxes in the competitor system. It may be necessary to utilize timing signals from the incumbent system to the competitor system in order to synchronize the control word generation.

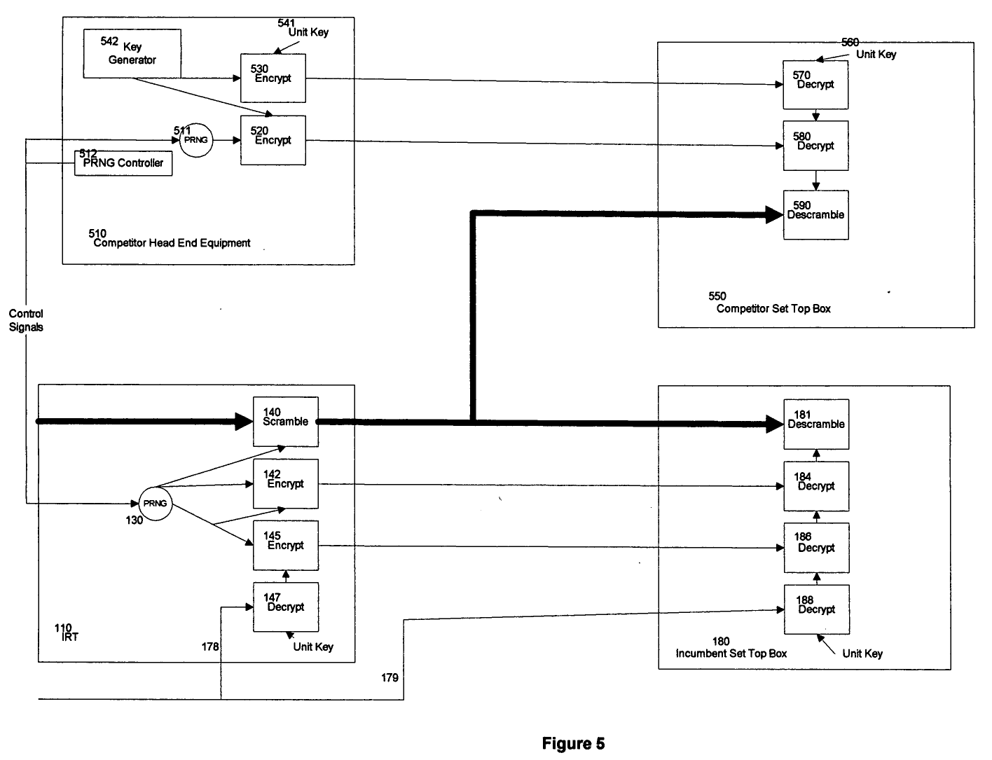

One embodiment of the control word prediction technique is illustrated in the system 500 of FIG. 5. In this embodiment, the PRNG 130 of the incumbent system is controlled by a PRNG controller 512 in the competitor head end equipment 510. The exact manner in which the PRNG controller 512 functions depends upon the implementation of the PRNG 130 in the incumbent system. In some embodiments, the PRNG controller 512 supplies the PRNG 130 with keys and/or initialization vectors and/or timing signals. Other methods of controlling the PRNG 130 will be utilized in other embodiments. The same control signals that are used to control the PRNG 130 in the incumbent IRT 110 are also used to control a replicated PRNG 511 in the competitor head end equipment 510. Alternatively, each competitor set top box 550 may be equipped with its own PRNG 511, in which case the control signals input to the PRNG 130 at the incumbent IRT 110 would be sent to each competitor set top box 550, preferably in encrypted form.

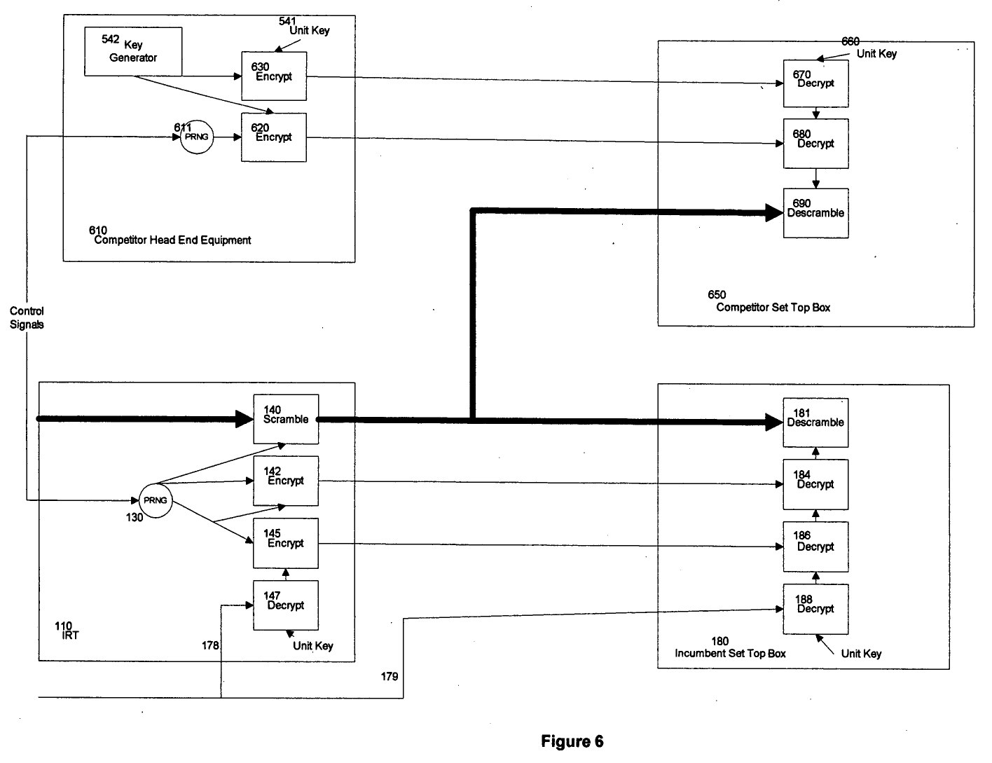

Another system 600 embodying this prediction technique is illustrated in FIG. 6. In the system 600, control signals from the PRNG 130 in the incumbent IRT 110 are input to the replicated PRNG 611 in the competitor head end equipment 610 such that the PRNG 611 duplicates the output of the PRNG 130.

As with the previous embodiment, it is also possible to equip each competitor set top box 650 with its own PRNG 611 and send the control signals from the PRNG 130 to each competitor set top box 650, again, preferably in encrypted form.

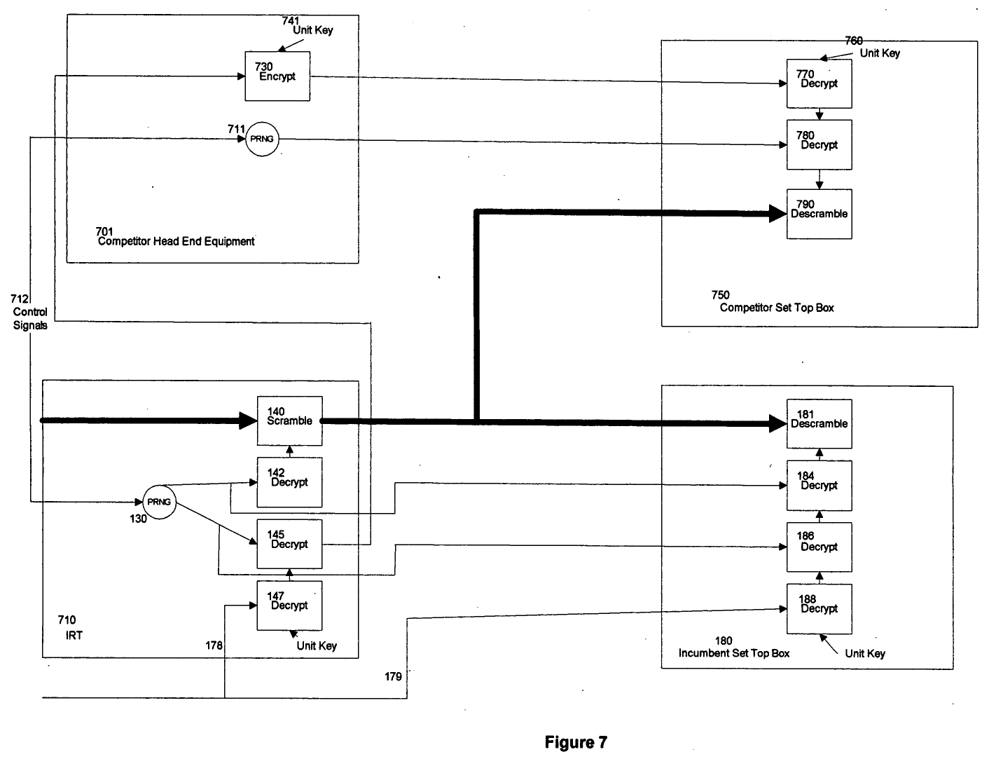

A third system 700 embodying the prediction technique is illustrated in FIG. 7. In the system 700, the output of the PRNG 130 is treated as an encrypted control word. A PRNG 711 in the competitor head end equipment 710, which is a replicated version of the PRNG 130 in the incumbent IRT 710, is controlled by control signals 712 that are taken from PRNG 130 to produce control words that are duplicates of the control words produced by PRNG 130. The duplicate control words are sent to the competitor set top boxes 750. Because these duplicate control words are treated as encrypted, and because a decrypted version of these control words are input to the scrambler 140 in the incumbent IRT 710, it is necessary for the competitor set top boxes 750 to decrypt these duplicate control words using the same key that was used to decrypt them by the decryptor 142 in the incumbent IRT 710. This is accomplished by copying a decrypted intermediate key supplied by the decryptor 145, encrypting the intermediate key with a unit key at encryptor 730 in the competitor head end equipment 701, and transmitting this encrypted intermediate key to the competitor set top boxes 750, where it is decrypted and then used to decrypt the encrypted version of the control words generated by the PRNG 711. In this embodiment, the unit key from database 741 that is used to encrypt the intermediate key is preferably a key that is known to all competitor set top boxes 750 rather than a key that is unique to a specific competitor set top box 750 (there may be additional levels of a key hierarchy, which are not shown in FIG. 7 and which may include a key that is unique to a competitor set top box 750, that are used to protect the unit key).

The third technique for operating an incumbent system and a competing system together is referred to as key (i.e., control word) injection. In this technique, the incumbent bead end equipment uses control words that are input (injected) into the incumbent system from an outside source. This source may be a device that forms part of the competitor head end equipment, or may be a device that is controlled by the competitor head end equipment and/or supplies the same control words to the competitor head end equipment. This technique may require modification to the incumbent head end equipment.

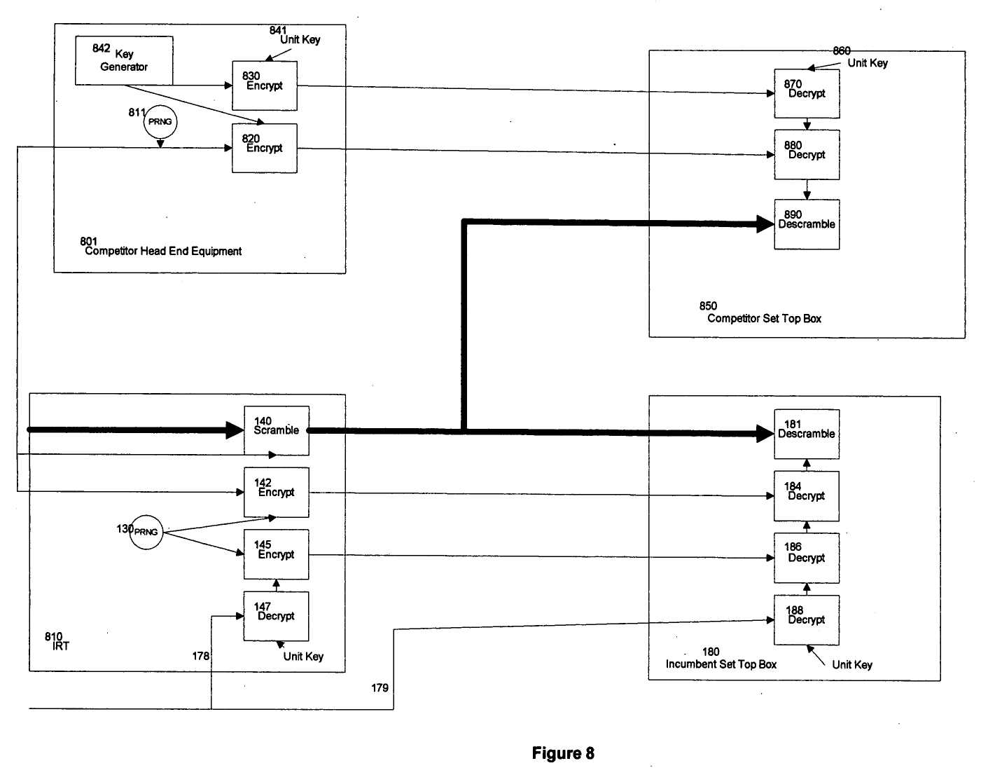

FIG. 8 illustrates a system 800 embodying this technique. In the system 800, the incumbent IRT 810 includes a PRNG 130. The PRNG 130 is used as a key source for generating keys that are used for the distribution of control words, but does not generate the control words themselves. Rather, the control words are generated by a PRNG 811 in the competitor head end equipment 801. This PRNG 811 injects the control words into the incumbent scrambler 140 and also supplies these control words to the encryptor 142 in the incumbent IRT 810 and the encryptor 820 in the competitor head end equipment 801 for distribution to the respective set top boxes 180, 850.

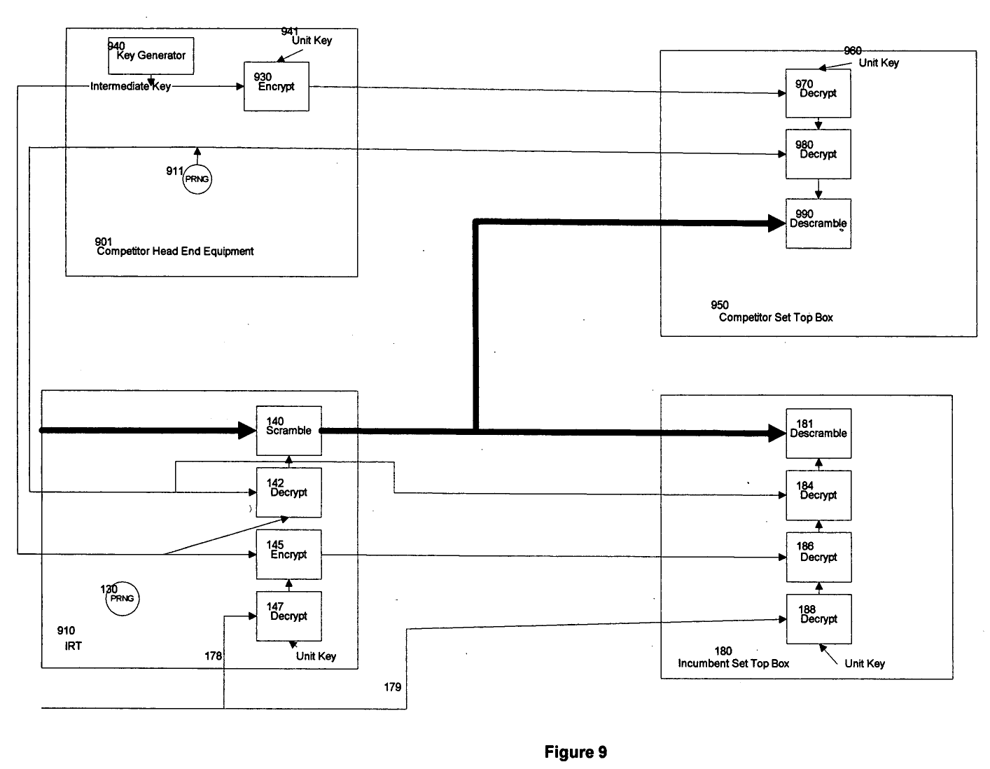

FIG. 9 illustrates a second system 900 embodying the injection technique. In this embodiment, the output of a PRNG is treated as an encrypted control similar to the system 200 of FIG. 2. However, in the system 900, the PRNG 911 that generates the encrypted control words is located in the competitor head end equipment 901. The PRNG 130 in the incumbent IRT 910 is not used in the system 900 of FIG. 9. In addition to injecting the encrypted control into the incumbent IRT 910, the competitor head end equipment 901 also injects the intermediate key into the decryptor 142, where it is used to decrypt the encrypted control word output by the PRNG 911 and is encrypted by encryptors 930, 145 in both the competitor head end equipment 901 and the incumbent IRT 910 for distribution to both the competitor and incumbent set top boxes 950, 980. This is done because it is necessary that both the incumbent and competitor set top boxes use the same key to decrypt the encrypted control words generated by the PRNG 911.

In other embodiments, the PRNG 130 in the incumbent IRT 910, rather than the intermediate key generator 942 in the competitor head end equipment 901) can be used to generate the intermediate key. In those embodiments, the intermediate key must be shared with the competitor head end equipment 901 so it can be distributed to both the incumbent and competitor set top boxes 180, 950.

Obviously, numerous other modifications and variations of the present invention are possible in light of the above teachings. It is therefore to be understood that within the scope of the appended claims, the invention may be practiced otherwise than as specifically described herein.

What is claimed is:

1. A method for broadcasting a television program, the method comprising the steps of:
generating a plurality of control words at an incumbent head end control word generator forming part of an incumbent head end system;
encrypting a television program using the control words;
providing a first key, the first key being known to incumbent set top boxes and not being known to competitor set top boxes;
providing a second key, the second key being known to competitor set top boxes and not being known to incumbent set top boxes;
extracting the control words from the incumbent head end system; and broadcasting the encrypted television program, the control words encrypted in the first key, and the control words encrypted in the second key.

2. The method of claim 1, wherein the control words are provided in unencrypted form.

3. The method of claim 1, wherein the control words are provided in encrypted form, further comprising the step of decrypting the control words using the first key for use in the encrypting step, wherein the extracting step is performed by extracting the control words after they have been decrypted using the first key.

4. The method of claim 1, further comprising the steps of
encrypting the first key using a first intermediate key, the first intermediate key being known to incumbent set top boxes;
encrypting the second key using a second intermediate key, the second intermediate key being known to competitor set top boxes;
transmitting the encrypted first key to incumbent set top boxes; and transmitting the encrypted second key to competitor set top boxes.

5. The method of claim 4, wherein the first key and the second key are transmitted in a single transport stream along with the television program.

6. A method for broadcasting a television program, the method comprising the steps of:
generating an original set of control words at an incumbent head end control word generator forming part of an incumbent head end system under the control of at least one control signal;
replicating the incumbent head end control word generator to form a competitor head end control word generator;
generating a duplicate set of control words using the control signal at the competitor head end control word generator;
encrypting a television program using the original set of control words;
broadcasting the encrypted television program, the original set of control words and the duplicate set of control words.

7. The method of claim 1, further comprising the steps of:
providing a first key, the first key being known to incumbent set top boxes and not being known to competitor set top boxes;
providing a second key, the second key being known to competitor set top boxes and not being known to incumbent set top boxes;
encrypting the original set of control words using the first key; and
encrypting the duplicate set of control words using the second key.

8. The method of claim 7, wherein the encrypted television program, the control words encrypted in the first key, and the control words encrypted in the second key are broadcast in a single multiplexed transport stream.

9. The method of claim 6, wherein the encrypted television program, the original set of control words and the duplicate set of control words are broadcast in a single multiplexed transport stream.

10. The method of claim 6, wherein the control words are generated in unencrypted form.

11. The method of claim 6, wherein the control words are generated in encrypted form, further comprising the steps of:
generating a first key;
decrypting the control words using the first key for use in the encrypting step; and
transmitting the first key to both competitor set top boxes and incumbent set top boxes.

12. The method of claim 6, wherein the first key is transmitted in encrypted form once in a second key that is known to incumbent set top boxes but not known to competitor set top boxes, and transmitted a second time in a third key that is known to competitor set top boxes but not known to incumbent set top boxes.

13. The method of claim 12, wherein the second key and the third key are transmitted in a single transport stream along with the television program.

14. The method of claim 6, wherein the control signal is generated by a control signal generator.

15. The method of claim 12, wherein the control signal generator forms part of the competitor head end equipment.

16. The method of claim 6, wherein the control signal is generated by the incumbent head end control word generator and transmitted to the competitor head end control word generator.

17. A method for broadcasting a television program, the method comprising the steps of:
generating a plurality of control words in encrypted form at a competitor head end control word generator not forming part of an incumbent head end system;
injecting the encrypted control words into an incumbent head end system;
decrypting the control words using a first key;
encrypting a television program using the decrypted control words in the incumbent head end system; and
broadcasting the encrypted television program and the encrypted control words to competitor set top boxes and incumbent set top boxes.

18. The method of claim 17, further comprising the step of broadcasting the first key to competitor set top boxes and incumbent set top boxes.

19. The method of claim 17, further comprising the step of broadcasting the first key in encrypted form to competitor set top boxes in a second key known to competitor set top boxes and not known to incumbent set top boxes.

20. The method of claim 18, further comprising the step of broadcasting the first key in encrypted form to incumbent set top boxes in a third key known to incumbent set top boxes and not known to competitor set top boxes.
